(19) United States
(12) Patent Application Publication
(10) Pub. No.: US 2015/0074181 A1
(43) Pub. Date: Mar. 12, 2015

(54) ARCHITECTURE FOR DISTRIBUTED SERVER-SIDE AND CLIENT-SIDE IMAGE DATA RENDERING

(71) Applicant: Calgary Scientific Inc., Calgary (CA)

(72) Inventors: Torin Arni Taerum, Calgary (CA); Matthew Charles Hughes, Calgary (CA); Michael Cousins, Calgary (CA); Eric John Chernuka, Calgary (CA); Jaret James Hargreaves, Calgary (CA)

(21) Appl. No.: 14/482,462

(22) Filed: Sep. 10, 2014

Related U.S. Application Data
(60) Provisional application No. 61/875,749, filed on Sep. 10, 2013.

(51) Int. Cl. H04L 29/06; G06T 15/00

(52) U.S. Cl. CPC H04L 67/42; G06T 15/00; H04L 63/08
USPC 709/203

(57) ABSTRACT

A scalable image viewing architecture that minimizes requirements placed upon a server in a distributed architecture. Image data is pushed to a cloud-based service and pre-processed such that the image data is optimized for viewing by a remote client computing device. The associated metadata is separated and stored, and made available for searching. 2D image data may be communicated and rendered by the remote client computing device; whereas 3D image data be rendered by the cloud-based service by imaging servers and communicated to client computing device.

### CROSS-REFERENCE TO RELATED APPLICATION

This application claims priority to U.S. Provisional Patent Application No. 61/875,749, filed Sep. 10, 2013, entitled “IMAGE VIEWING ARCHITECTURE INCLUDING SERVER-SIDE AND CLIENT-SIDE IMAGE DATA RENDERING,” the disclosure of which is incorporated herein by reference in its entirety.

### BACKGROUND

In systems that provide ubiquitous remote access to graphical image data in a resource sharing network, adequate performance and scalability becomes a challenge. For example, for operations that are performed at a central server, scalability may not be optimized. For operations that are performed at a client, large datasets may take an unacceptable amount of time to transfer across the network. In addition, some client devices, such as hand-held devices, may not have sufficient computing power to effectively manage heavy processing operations. For example, in healthcare it may be desirable to access to patient studies that are housed within a clinic or hospital. In particular, Picture Archiving and Communication Systems (PACS) may not provide ubiquitous remote access to the patient studies; rather, may be limited to a local area network (LANS) that connects the PACS server to dedicated medical imaging workstations. Other applications, such as CAD design and seismic analysis may have similar challenges, as such applications may be used to produce complex images.

### SUMMARY

Disclosed herein are systems and methods for distributed rendering of 2D and 3D image data in a remote access environment where 2D image data is streamed to a client computing device and 2D images are rendered on the client computing device for display, and 3D image data is rendered on a server computing device and the rendered 3D images are communicated to the client computing device for display. In accordance with an aspect of the present disclosure, there is provided a method of distributed rendering of image data in a remote access environment connecting a client computing devices to a service. The method may include storing 2D image data in a database associated with the service; receiving a request at the service from the client computing device; and determining if the request is for the 2D image data or 3D images. If the request is for the 2D image data, then the 2D image data is streamed to the client computing device for rendering of 2D images for display. If the request is for 3D images, then a server computing device associated with the service renders the 3D images from the 2D image data and communicates the 3D images to the client computing device for display.

In accordance with aspects of the disclosure, there is provided a method for distributed rendering of image data in a remote access environment connecting a client computing devices to a service. The method may include storing 2D image data in a database associated with the service; receiving a request at the service from the client computing device; and determining if the request is for the 2D image data or 3D images. If the request is for the 2D image data, then the method may include streaming the 2D image data to the client computing device for rendering of 2D images at the client computing device for display. However, if the request is for 3D images, then the method may include rendering, at a server computing device associated with the service, the 3D images from the 2D image data and communicating the rendered 3D images to the client computing device for display.

In accordance with other aspects of the disclosure, there is provided a method for providing a service for distributed rendering of image data between the service and a remotely connected client computing device. The method may include receiving a connection request from the client computing device; authenticating a user associated with the client computing device to present a user interface showing images available for viewing by the user; and receiving a request for images, and if the request of images is for 2D image data, then streaming the 2D image data from the service to the client computing device, or if the request is for 3D images, then rendering the 3D images at the service and communicating the rendered 3D images to the client computing device.

In accordance with other aspects of the disclosure, a tangible computer-readable storage medium storing a computer program having instructions for distributed rendering of image data in a remote access environment is disclosed. The instructions may execute a method comprising the steps of storing 2D image data in a database associated with the service; receiving a request at the service from the client computing device; determining if the request is for the 2D image data or 3D images; and if the request is for the 2D image data, then streaming the 2D image data to the client computing device for rendering of 2D images at the client computing device for display; or if the request is for 3D images, then rendering, at a server computing device associated with the service, the 3D images from the 2D image data and communicating the rendered 3D images to the client computing device for display.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagrams illustrating a system for providing remote access to image data and other data at a remote device via a computer network;

FIG. 2A illustrates aspects of preprocessing of image data and metadata in the environment of FIG. 1;

FIG. 2B illustrates data flow of 2D image data and metadata with regard to preprocessing of 2D image data and server-side rendering of 3D and/or MIP/MPR data and client-side rendering of 2D data in the environment of FIG. 1;

FIG. 3 illustrates a flow diagram of example operations performed within the environment of FIGS. 1 and 2 to service requests from client computing devices;

FIG. 4 illustrates a flow diagram of example client-side image data rendering operations;

FIG. 5 illustrates a flow diagram of example operations performed as part of a server-side rendering of the image data;

FIG. 6 illustrates a flow diagram of example operations performed within the environment of FIG. 1 to provide for collaboration; and

FIG. 7 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

Overview

In accordance with aspects of the present disclosure, remote users may access images using, e.g., a remote service, such as a cloud-based service. In accordance with a type of images being requested, certain types may be rendered by the remote service, whereas other types may be rendered locally on a client computing device.

For example, in the context of high resolution medical images, a hosting facility, such as a hospital, may push patient image data to the remote service, where it is pre-processed and made available to remote users. The patient image data (source data) is typically a series of DICOM files that each contain one or more images and metadata. The remote service coverts the source data into a sequence of 2D images having a common format which are communicated to a client computing device in a separately from the metadata. The client computing device renders the sequence of 2D images for display. In another aspect, the sequence of 2D images may be further processed into a representation suitable for 3D or Maximum Intensity Projection (MIP)/Multi-Planar Reconstruction (MPR) rendering by an imaging server at the remote service. The 3D or MIP/MPR rendered image is communicated to the client computing device. The 3D image data may be visually presented to a user as a 2D projection of the 3D image data.

While the above example describes aspects of the present disclosure with respect to medical images, the concepts described herein may be applied to any images that are transferred from a remote source to a client computing device. For example, in the context of other imagery, such as computer-aided design (CAD) engineering design, seismic imagery, etc. aspects of the present disclosure may be utilized to render a 2D schematic of a design on a client device, where 3D model of the design may be rendered on the imaging server of the remote service to take advantage of the a faster, more powerful graphics processing unit (GPU) array at the remote service. The rendered 3D model would be communicated to the client computing device for viewing. Such an implementation may be used, for example, to view a 2D schematic of a building on-site, whereas a 3D model of the same building may be rendered on a GPU array of the remote service. Similarly, such an implementation may be used, for example to render 2D images at the client computing device from 2D reflection seismic data or to render 3D images at the remote service from either raw 3D reflection seismic data or by interpolating 2D reflection seismic data that are communicated to the client computing device for viewing. For example, 2D seismic data may be used for well monitoring and other data sets, whereas 3D seismic data would be use for a reservoir analysis.

Thus, present disclosure provides for distributed image processing whereby less complex image data (e.g., 2D image data) may be processed by the client computing device and more complex image data (e.g., 3D image data) may be processed remotely and then communicated to the client computing device. In addition, the remote service may preprocess any other data associated with image data in order to optimize such data for search and retrieval in a distributed database arrangement. As such, the present disclosure provides a system and method for transmitting data efficiently over a network, thus conserving bandwidth while providing a responsive user experience.

Example Environment

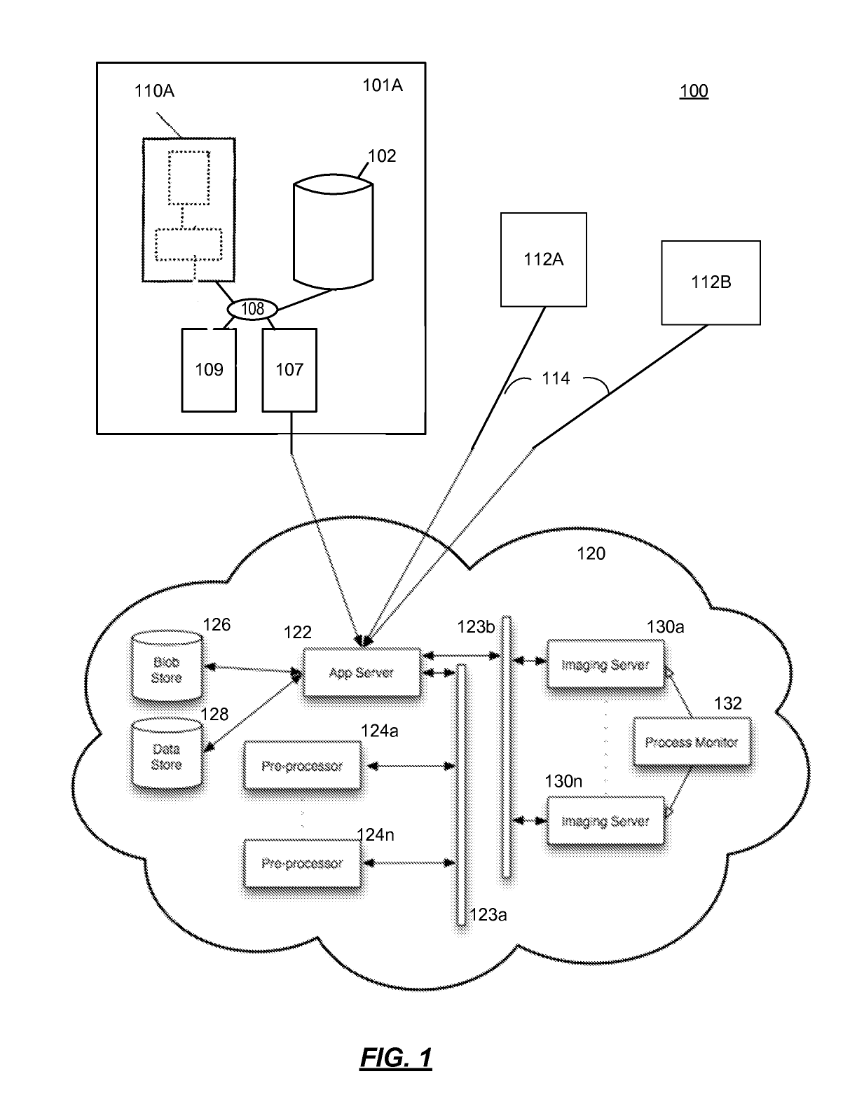

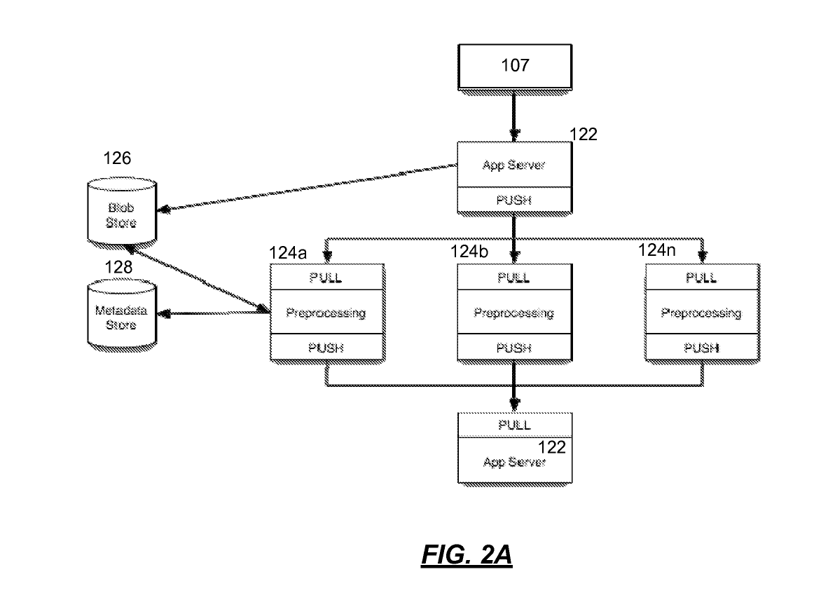

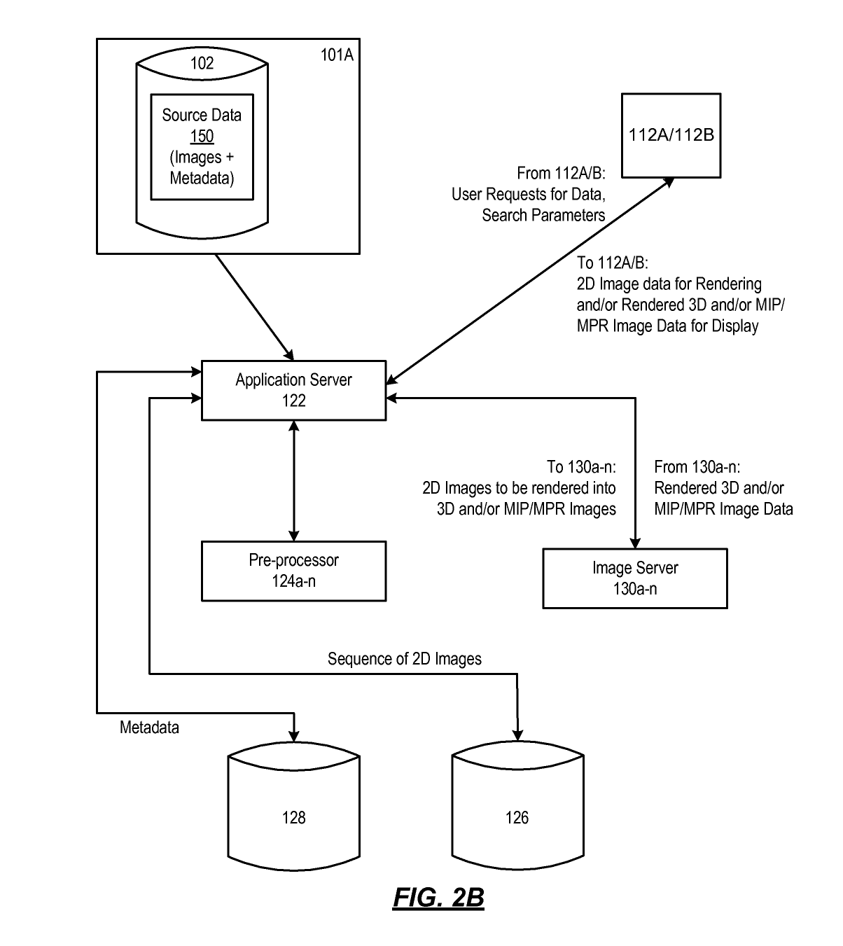

With the above overview as an introduction, reference is now made to FIGS. 1-2 where there is illustrated an environment 100 for image data viewing, collaboration and transfer via a computer network. In this example, and with reference to a medical imaging application for viewing patient data for the purpose of illustration, a server computer 109 may be provided at a facility 101A (e.g., a hospital or other care facility) within an existing network as part of a medical imaging application to provide a mechanism to access data files, such as patient image files (studies) resident within, e.g., a Picture Archiving and Communication Systems (PACS) database 102. Using PACS technology, a data file stored in the PACS database 102 may be retrieved and transferred to, for example, a diagnostic workstation 110A using a Digital Imaging and Communications in Medicine (DICOM) communications protocol where it is processed for viewing by a medical practitioner. The diagnostic workstation 110A may be connected to the PACS database 102, for example, via a Local Area Network (LAN) 108 such as an internal hospital network or remotely via, for example, a Wide Area Network (WAN) 114 or the Internet. Metadata and image data may be accessed from the PACS database 102 using a DICOM query protocol, and using a DICOM communications protocol on the LAN 108, information may be shared.

The server computer 109 may comprise a RESOLUTION MD server available from Calgary Scientific, Inc., of Calgary, Alberta, Canada. The server computer 109 may be one or more servers that provide other functionalities, such as remote access to patient data files within the PACS database 102, and a HyperText Transfer Protocol (HTTP)-to-DICOM translation service to enable remote clients to make requests for data in the PACS database 102 using HTTP.

A pusher application 107 communicates patient image data from the facility 101A (e.g., the PACS database 102) to a cloud service 120. The pusher application 107 may make HTTP requests to the server computer 109 for patient image data, which may be retrieved from by the PACS database 102 by the server computer 109 and returned to the pusher application 107. The pusher application 107 may retrieve patient image data on a schedule or as it becomes available in the PACS database 102 and provide it to the cloud service 120.

Client computing devices 112A or 112B may be wireless handheld devices such as, for example, an IPHONE or an ANDRIOD that communicate via a computer network 114 such as, for example, the Internet, to the cloud service 120. The communication may be HyperText Transport Protocol (HTTP) communication with the cloud service 120. For example, a web client (e.g., a browser) or native client may be used to communicate with the cloud service 120. The web client may be HTML5 compatible. Similarly, the client computing devices 112A or 112B may also include a desktop/notebook personal computer or a tablet device. It is noted that the connections to the communication network 114 may be any type of connection, for example, Wi-Fi (IEEE 802.11x), WiMax (IEEE 802.16), Ethernet, 3G, 4G, LTE, etc.

The cloud service 120 may host the patient image data, process patient image data and provide patient image data to, e.g., one or more of client computing devices 112A or 112B. An application server 122 may provide for functions such as authentication and authorization, patient image data access, searching of metadata, and application state dissemination. The application server 122 may receive raw image data from the pusher application 107 and place the raw image data into a binary large object (blob) store 126. Other patient-related data (i.e., metadata) is placed by the application server 122 into a data store 128.

The application server 122 may be virtualized, that is, created and destroyed based on, e.g., load or other requirements to perform the tasks associated therewith. In some implementations, the application server 122 may be, for example, a node.js web server or a java application server that services requests made by the client computing devices 112A or 112B. The application server 122 may also expose APIs to enable clients to access and manipulate data stored by the cloud service 120. For example, the APIs may provide for search and retrieval of image data. In accordance with some implementations, the application server 122 may operate as a manager or gateway, whereby data, client requests and responses all pass through the application server 122. Thus, the application server 122 may manage resources within the environment hosted by the cloud service 120.

The application server 122 may also maintain application state information associated with each client computing device 112A or 112B. The application state may include, such as, but not limited to, a slice number of the patient image data that was last viewed at the client computing device 112A or 112B for viewing, etc. The application state may be represented by, e.g., an Extensible Markup Language (XML) document. Other representations of the application state may be used. The application state associated with one client computing device (e.g., 112A) may be accessed by another client computing device (e.g., 112B) such that both client computing devices may collaboratively interact with the patient image data. In other words, both client computing devices may view the patient image data such that changes in the display are synchronized to both client computing devices in the collaborative session. Although only two client computing devices are shown, any number of client computing devices may participate in a collaborative session.

In accordance with some implementations, the blob store 126 may be optimized for storage of image data, whereas the data store 128 may be optimized for search and rapid retrieval of other types of information, such as, but is not limited to a patient name, a patient birth date, a name of a doctor who ordered a study, facility information, or any other information that may be associated with the raw image data. The blob store 126 and data store 128 may hosted on, e.g., Amazon S3 or other service which provides for redundancy, integrity, versioning, and/or encryption. In addition, the blob store 126 and data store 128 may be HIPPA compliant. In accordance with some implementations, the blob store 126 and data store 128 may be implemented as a distributed database whereby application-dependent consistency criteria are achieved across all sites hosting the data. Updates to the blob store 126 and the data store 128 may be event driven, where the application server 122 acts as a master.

Message buses 123a-123b may be provided to decouple the various components with the cloud service 120, and to provide for messaging between the components, such as pre-processors 124a-124n and imaging servers 130a-130n. Messages may be communicated on the message buses 123a-123b using a request/reply or publish/subscribe paradigm. The message buses 123a-123b may be, e.g., ZeroMQ, RabbitMQ (or other AMQP implementation) or Amazon SQS.

With reference to FIGS. 1, 2A and 2B, the pre-processors 124a-124n respond to messages on the message buses 123a. For example, when raw image data is received by the application server 122 and is need of pre-processing, a message may be communicated by the application server 122 to the pre-processors 124a-124n. As shown in FIG. 2B, source data 150 (raw patient image data) may be stored in the PACS database 102 as a series of DICOM files that each contain one or more images and metadata. The pre-processing performed by the pre-processors 124a-124n may include, e.g., separation and storage of metadata, pixel data conversion and compression, and 3D down-sampling. As such, the source data may be converted into a sequence of 2D images having a common format that are stored in the blob store 126, whereas the metadata is stored in the data store 128. For example, as shown in FIG. 2A, the processes may operate in it a push-pull arrangement such that when the application server 122 pushes data in a message, any available pre-processor may pull the data, perform a task on the data, and push the processed data back to the application server 122 for storage in the blob store 126 or the data store 128.

The pre-processors 124a-124n may perform optimizations on the data such that the data is formatted for ingestion by the client computing devices 112A or 112B. The pre-processors 124a-124n may process the raw image data and store the processed image data in the blob store 126 until requested by the client computing devices 112A or 112B. For example, 2D patient image data may be formatted as Haar Wavelets. Other, non-image patient data (metadata) may be processed by the pre-processors 124a-124n and stored in the data store 128. Any number of pre-processors 124a-124n may be created and/or destroyed in accordance, e.g., processing load requirements to perform any task to make the patient image data more usable or accessible to the client computing devices 112A and 112B.

The imaging servers 130a-130n provide for distributed rendering of image data. Each imaging server 130a-130n may serve multiple users. For example, as shown in FIG. 2B, the imaging servers 130a-130n may process the patient image data stored as the sequence of 2D image in the blob store 126 to provide rendered 3D imagery and/or Maximum Intensity Projection (MIP)/Multi-Planar Reconstruction (MPR) image data, to the client computing devices 112A and 112B. For example, a user at one of the computing devices 112A or 112B may make a request to view a 3D representation of a volume with 3D orthogonal MPR slices. Accordingly, an imaging server 130 may render the 3D orthogonal MPR slices, which are communicated to the requesting client computing device via the application server 122.

In accordance with some implementations, a 3D volume is computed from a set of N, X by Y images. This forms a 3D volume with a size of X×Y×N voxels. This 3D volume may then be decimated to reduce the amount of data that must be processed by the imaging servers 130a-130n to generate an image. For example, a reduction of 75% may be provided along each axis, which produces the sufficient results without a significant loss of fidelity in the resulting rendered imagery. A longest distance between any two corners of the decimated 3D volume can be used to determine the size of the rendered image. For example, a set of 1000 512×512 CT slices may be used to produce a 3D volume. This volume may be decimated to a size of 384×384×750, so the largest distance between any two corners is \sqrt{384²+384²+750²} voxels, or approximately 926. The rendered image is, therefore, 926×926 pixels in order to capture information at a 1:1 relationship between voxels and pixels. In the event that the client's viewport (display) is smaller than 926×926, the client's viewport size is used, rather than the image size in order to determine the size of the rendered image. The rendered images may be scaled-up by a client computing device when displayed to a user if the viewport is larger than 926×926. As such, a greater number of images may be rendered at the imaging servers 130a-130n and the image rendering time is reduced.

Thus, when the image servers 130a-130n are requested to render 3D volumetric views, a set of 2D images may be decimated from 512×512×N pixels to 384×384×N pixels before processing, as noted above. However, for MIP/MPR images, the 2D image data may be used in its original size.

A process monitor 132 is provided to insure that the imaging servers 130a-130n are alive and running. Should the process monitor 132 find that a particular imaging server is unexpectedly stopped; the process monitor 132 may restart the imaging server such that it may service requests.

Thus, the environment 100 enables cloud-based distributed rendering of patient imaging data associated with a medical imaging application or other types of image data and their respective viewing/editing applications. Further, client computing devices 112A or 112B may participate in a collaborative session and each present a synchronized view of the display of the patient image data.

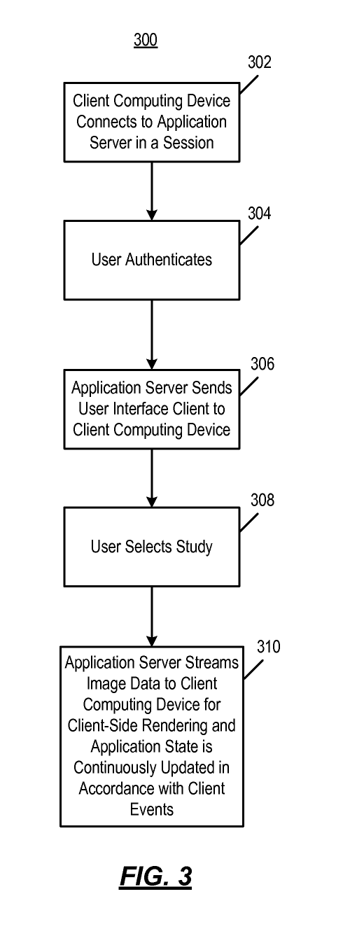

FIG. 3 illustrates a flow diagram 300 of example operations performed within the environment of FIGS. 1 and 2 to service requests from client computing devices 112 A and 112 B. As noted above, the application server 122 receives patient image data from the pusher application 107 on a periodic basis or as patient data becomes available. The operational flow of FIG. 3 begins at 302 where a client computing device connects to the application server in a session. For example, the client computing device 112A may connect to the application server 122 at a predetermined uniform resource locator (URL). The user of the client computing device 112A may use, e.g., a web browser or a native application to make the connection to the application server 122.

At 304, the user authenticates with the cloud service 120. For example, due to the sensitive nature of patient image data, certain access controls may be put in place such that only authorized users are able to view patient image data. At 306, the application server sends a user interface client to the client computing device. A user interface client may be downloaded to the client computing device 112A to enable a user to select a patient study or to search and retrieve other information from the blob store 126 or the data store 128. For example, an HTML5 study browser client may be downloaded to the client computing device 112A that provides a dashboard whereby a user may view a thumbnail of a patient study, a description, a patient name, a referring doctor, an accession number, or other reports associated with the patient image data stored at the cloud service 120. Different version of the user interface client may be designed for, e.g., mobile and desktop applications. In some implementations, the user interface client may be a hybrid application for mobile client computing devices where it may be installed having both native and HTML5 components.

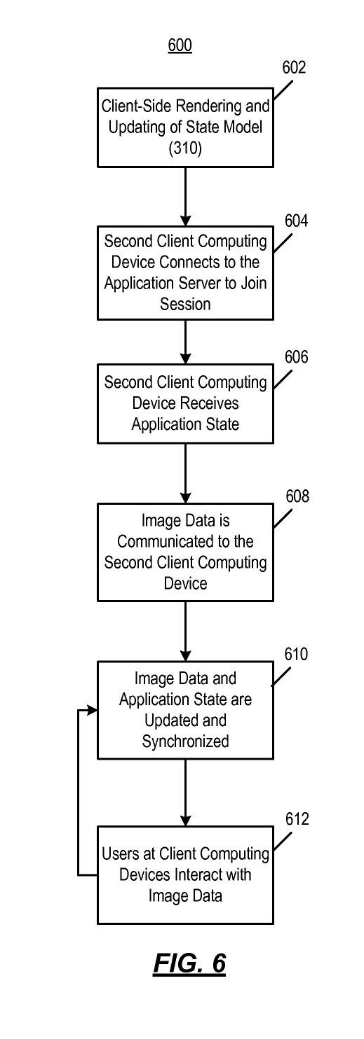

The 308, user selects a study. For example, using the study browser, the user of the client computing device 112A may select a study for viewing at the client computing device 112A. At 310, patent image data associated with the selected study is streamed to the client computing device 112A from the application server 122. The patient image data may be communicated using an XMLHttpRequest (XHR) mechanism. The patient image data may be provided as complete images or provided progressively. Concurrently, an application state associated with the client computing device 112A is updated at the application server 122 in accordance with events at the client computing device 112A. The application state is continuously updated at the application server 122 to reflect events at the client computing device 112A, such as the user scrolling through the slices. The user may scroll slices or perform other actions that change application state while the image data is being sent to the client. As will be described later with reference to FIG. 6, the application state may provided to more than one client computing device connected to a collaboration session in order to provide synchronize views and enable collaboration among the multiple client computing devices that are simultaneously viewing imagery associated with a particular patient.

Thus, in accordance with the above, the patient image data maintained at the cloud service 120 is made available through the interaction of one or more the client computing device 112A with the application server 122.

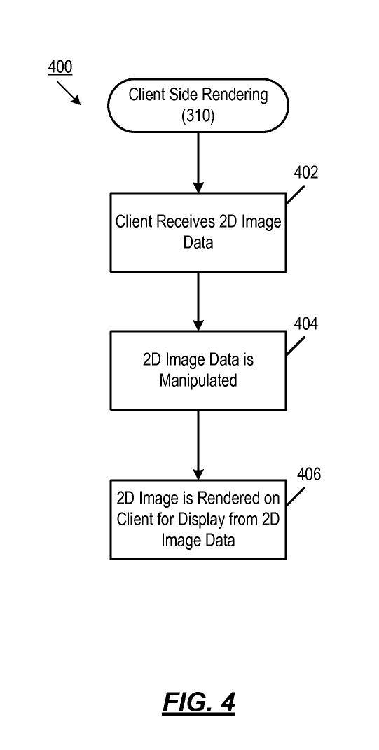

FIG. 4 illustrates a flow diagram 400 of example client-side image rendering operations performed at the client computing device. At 402, the 2D image data is received at the client computing device as streaming data, as described at 310 in accordance with the operational flow 300. At 404, the 2D image data is manipulated. The image data may be manipulated as an ArrayBuffer a data type or other JavaScript typed arrays.

At 406, a display image is rendered at the client computing device from the 2D image data. For example, the display image may be rendered using WebGL, which provides for rendering graphics within a web browser. In some implementations, Canvas may also be used for client-side image rendering. Metadata associated with the image data may be utilized by the client computing device to aid the performance of the rendering.

Thus, in accordance with the flow diagram 400, client-side rendering of the image data provides for high-performance presentation of images as the data need only be communicated to the client computing device for display, eliminating any need for round-trip communication with the cloud service 120. In addition, each client can render the image data in a manner particular to the client.

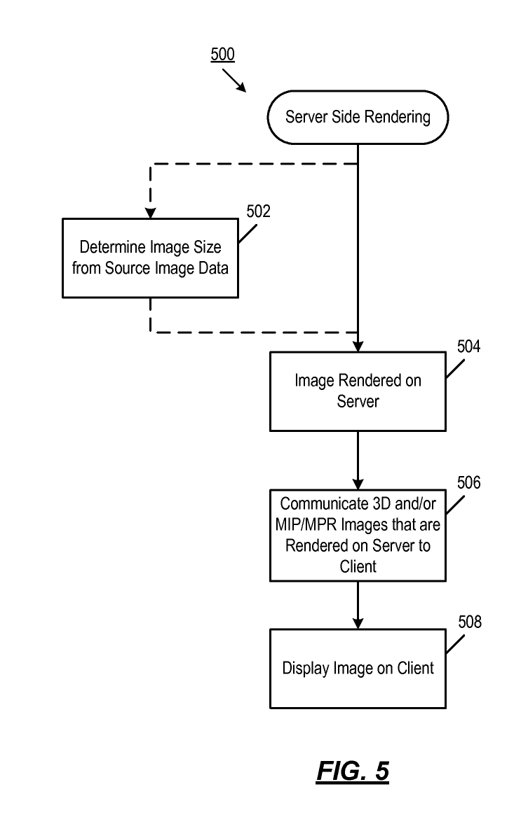

FIG. 5 illustrates a flow diagram 500 of example operations performed as part of a server-side rendering of the image data. As described above in FIG. 4, 2D rendering of images is on the client computing device. The operational flow 500 may be used to provide 3D images and/or MIP/MPR images to the client computing device, where the 3D images and/or MIP/MPR images are rendered by, e.g., one of the imaging servers 130a-103n, and communicated to the client computing device for display. Thus, the present disclosure provides a distributed image rendering model where 2D images are rendered on the client and 3D and/or MIP/MPR images are rendered on the server.

At 502, the server-side rendering begins in accordance with, e.g., a request made by the user of the client computing device 112A that is received by the application server 122. For example, the user may wish to view the image data in 3D to perform operations such as, but not limited to, a zoom, pan or a rotate of the image associated with, e.g., a patient. The process monitor 132 may respond to insure that an imaging server 130 is available to service the user request. As noted above, each imaging server can service multiple users.

Optionally, at 504, the image size is determined from the source image data. As noted above, the data size may be reduced for 3D volumetric rendering, whereas the original size is used for MIP/MPR images. At 506, the image is rendered. For example, the imaging servers 130a-130n may render imagery in OpenGL.

At 508, rendered image is communicated to the client computing device. For example, the entire image may be communicated to the client computing device, which is then displayed on the client computing device 510. In accordance with the present disclosure, the client computing device may scale the image to fit within the particular display associated with the client computing device.

Thus, the image servers may provide the same-sized images to each client computing device that requests 3D image data, which reduces the size of images to be transmitted and conserves bandwidth. As such, scaling of the data is distributed across the client computing devices, rather than being performed by the imaging servers.

FIG. 6 illustrates a flow diagram 600 of example operations performed within the environment of FIG. 1 to provide for collaboration. At 602, a first client computing device (e.g., 112A) has established a session with the application server 122 and 2D image data is being streamed to the client computing device. As such, client-side rendering of the 2D image data and the application state updating has begun as described at 310. At 604, a second client computing device connects to the application server to join the session. For example, the client computing device 112B may connect to the application server 122 at the same URL used by the first client computing device (e.g., 112A) to connect to the application server 112.

At 606, the second client computing device receives the application state associated with the first client computing device from the application server. Thus, a collaboration session between the client computing devices 112A and 112B may now be established. At 608, image data associated with the first client computing device (112A) is communicated to the second client computing device (112B). After 608, the second client computing device (112B) will have knowledge of first computing device's application state and will be receiving image data. Next, at 610, the image data and the application state are updated in accordance with events at both client computing devices 112A and 112B such that both of the client computing devices 112A and 112B will be displaying the same image data in a synchronized fashion. At 612, the collaborators may view and interact with the image data to, e.g. discuss the patient's condition. Interacting with the image data may cause the image data and application state to be updated in a looping fashion at 610-612.

Although the present disclosure has been described with reference to certain operational flows, other flows are possible. Also, while the present disclosure has been described with regard to patient image data, it is noted that any type of image data may be processed by the cloud service and/or (collaboratively) viewed by one or more client computing devices.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

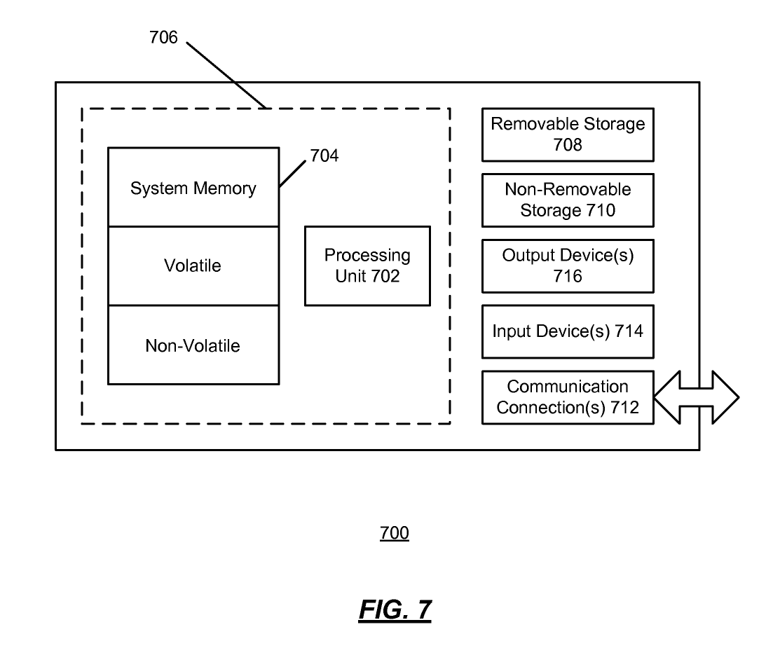

FIG. 7 shows an exemplary computing environment in which example embodiments and aspects may be implemented. The computing system environment is only one example of a suitable computing environment and is not intended to suggest any limitation as to the scope of use or functionality.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for distributed rendering of image data in a remote access environment connecting a client computing devices to a service, comprising:
storing 2D image data in a database associated with the service;
receiving a request at the service from the client computing device;
determining if the request is for the 2D image data or 3D images; and
if the request is for the 2D image data, then streaming the 2D image data to the client computing device for rendering of 2D images at the client computing device for display; or
if the request is for 3D images, then rendering, at a server computing device associated with the service, the 3D images from the 2D image data and communicating the rendered 3D images to the client computing device for display.

2. The method of claim 1, further comprising:
receiving raw image data at the service from a data source; and
pre-processing the raw image data or separate metadata from the raw image data and to create the 2D image; and
separately storing the 2D image data and the metadata.

3. The method of claim 2, wherein the data source includes a pusher application that sends the raw data on a periodic basis or as the raw data becomes available.

4. The method of claim 2, wherein the raw data is medical image data.

5. The method of claim 2, wherein the raw data is computer-aided design (CAD) image data.

6. The method of claim 2, wherein the raw data is seismic image data.

7. The method of claim 2, further comprising providing the metadata to the client computing device in response to the request.

8. The method of claim 1, wherein providing the 2D image data further comprises:
receiving a connection to the service from the client computing device at a predetermined uniform resource locator (URL);
authenticating a user of the client computing device at the service;
communicating a user interface to the client computing device for display to the user; and
receiving the request from the user interface.

9. The method of claim 8, wherein the user interface is provided as a HTML5 compatible web client.

10. The method of claim 1, further comprising continuously updating an application state associated with the client computing device, wherein the application state contains information about the client computing device.

11. The method of claim 10, wherein the application state contains information regarding an image that is being displayed to a user of the client computing device.

12. The method of claim 10, further comprising establishing a collaboration session between multiple client computing devices that are simultaneously viewing either the 2D image data or the 3D images.

13. The method of claim 1, further comprising:
determining if the request is for Maximum Intensity Projection (MIP)/Multi-Planar Reconstruction (MPR) data;
rendering the MIP/MPR data from the 2D image data at the server computing device; and
communicating the MIP/MPR data to the client computing device for display.

14. The method of claim 1, wherein rendering the 3D images from the 2D image data further comprises:
determining an image size to be rendered from the 2D image data; and
rendering the 3D images having the image size determined from the 2D image data.

14. The method of claim 14, further comprising scaling, at the client computing device, the 3D images in accordance with a display size associated with the client computing device.

16. A method for providing a service for distributed rendering of image data between the service and a remotely connected client computing device, comprising:
receiving a connection request from the client computing device;
authenticating a user associated with the client computing device to present a user interface showing images available for viewing by the user; and
receiving a request for images, and if the request of images is for 2D image data, then streaming the 2D image data from the service to the client computing device, or if the request is for 3D images, then rendering the 3D images at the service and communicating the rendered 3D images to the client computing device.

17. The method of claim 16, further comprising rendering the 3D images at the service from the 2D image data.

18. The method of claim 16, further comprising rendering 2D images at the client computing device from the 2D image data.

19. The method of claim 16, further comprising communicating metadata associated with the images from the service to the client computing device.

20. The method of claim 16, further comprising pre-processing raw image data into a format for ingestion by the client computing device.

21. The method of claim 20, further comprising formatting the raw image data into the 2D image data in advance of the request for images.

22. A tangible computer-readable storage medium storing a computer program having instructions for distributed rendering of image data in a remote access environment, the instructions executing a method comprising the steps of:
storing 2D image data in a database associated with the service;
receiving a request at the service from the client computing device;
determining if the request is for the 2D image data or 3D images; and
if the request is for the 2D image data, then streaming the 2D image data to the client computing device for rendering of 2D images at the client computing device for display; or
if the request is for 3D images, then rendering, at a server computing device associated with the service, the 3D images from the 2D image data and communicating the rendered 3D images to the client computing device for display.
